(19) United States
(12) Patent Application Publication
(10) Pub. No.: US 2018/0187120 A1
(43) Pub. Date: Jul. 5, 2018

(54) AUTOMATIC TRANSMISSION OIL COMPOSITION IMPROVING FRICTIONAL PROPERTY AND FUEL ECONOMY AND CLUTCH FOR AUTOMATIC TRANSMISSION COMPRISING THE SAME

(71) Applicants: Hyundai Motor Company, Seoul (KR); Kia Motors Corporation, Seoul (KR)

(72) Inventor: Jung Joon OH, Seongnam-si (KR)

(73) Assignees: Hyundai Motor Company, Seoul (KR); Kia Motors Corporation, Seoul (KR)

(21) Appl. No.: 15/697,177

(22) Filed: Sep. 6, 2017

(30) Foreign Application Priority Data
Dec. 29, 2016 (KR) 10-2016-0181897

(51) Int. Cl. C10M 169/04; F16D 13/52; C10M 111/04; C10M 107/24; C10M 105/00; C10M 129/68

(52) U.S. Cl. CPC C10M 169/04; F16D 13/52; C10M 111/04; F16D 69/00; C10M 105/00; C10M 129/68; C10M 107/24

(57) ABSTRACT

Provided herein is a composition used for a clutch of an automatic transmission. The composition improves fuel economy and abrasion resistance by enhancing a frictional property of a clutch and improving efficiency of the automatic transmission.

### CROSS-REFERENCE(S) TO RELATED APPLICATION(S)

The present application claims under 35 U.S.C. § 119(a) benefits of and priority to Korean Patent Application No. 10-2016-0181897, filed on Dec. 29, 2016, the entire contents of which are incorporated herein by reference for all purposes.

### BACKGROUND OF THE INVENTION

### Field of the Invention

The present invention relates to a composition used for a clutch of an automatic transmission, and more particularly to an automatic transmission oil composition capable of improving fuel economy and abrasion resistance by enhancing a frictional property of a clutch and improving efficiency of the automatic transmission.

### Description of Related Art

In recent years, many efforts have been made to improve fuel efficiency of a vehicle under the influence of high oil prices and unusual weather resulting from global warming, and even in the field of an automatic transmission many technologies have been applied to contribute to improvement of the fuel efficiency.

An additional clutch is mounted on the automatic transmission depending on a design of the vehicle and the type of the transmission, and a condition essential for the clutch is that power should be able to be efficiently transmitted through high friction between plates. Therefore, a friction characteristic of the clutch is very important. When the friction between the plates decreases, the power cannot be effectively transmitted. However, when the friction is excessively high, abrasion between metals may occur severely, which may result in poor durability.

The above information disclosed in this Background section is only for enhancement of understanding of the background of the invention and therefore it may contain information that does not form the related art that is already known in this country to a person of ordinary skill in the art.

### BRIEF SUMMARY

The present invention has been made in an effort to solve the above-described problems associated with the related art.

The present invention is directed to providing an automatic transmission oil composition capable of improving power transmission efficiency of a plate by improving a friction property of a clutch for an automatic transmission.

The present invention is also directed to providing an automatic transmission oil composition capable of improving durability of a clutch for an automatic transmission together with power transmission efficiency.

The present invention are not limited to the described above. The present invention will be more apparent in the description below and implemented by means described in the claims and a combination thereof.

In addition, the present invention provides an automatic transmission oil composition with improved friction property and fuel economy including about 68 wt % to 80 wt % of base oil, about 5 wt % to 15 wt % of polyalkylene glycol oil, and about 3 wt % to 10 wt % of a succinic anhydride derivative represented by the following Chemical Formula 1.

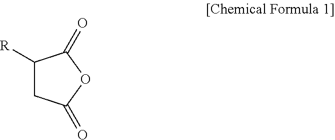

(R is an alkenyl group of C₂-C₃₀.)

In a preferred embodiment, the polyalkylene glycol oil may have a molecular weight of about 200 g/mol to 1,200 g/mol.

In another preferred embodiment, the polyalkylene glycol oil may have a kinematic viscosity of 3 cSt to 6 cSt.

In still another preferred embodiment, the polyalkylene glycol oil may be any one of polyethylene glycol and polypropylene glycol or mixtures thereof.

In yet another preferred embodiment, the succinic anhydride derivative may be a compound represented by the following Chemical Formula 2.

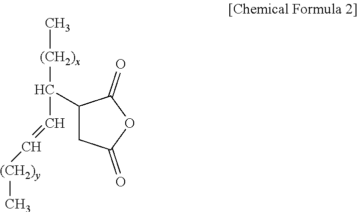

(x and y are integers of 1 to 30, respectively.)

In still yet another preferred embodiment, the succinic anhydride derivative may be a compound represented by the following Chemical Formula 3.

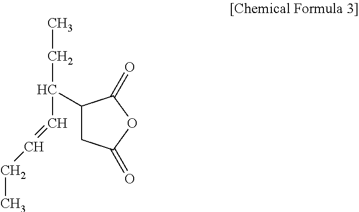

In a further preferred embodiment, a weight ratio of the polyalkylene glycol oil and the succinic anhydride derivative may be about 0.7 to 3.3:1.

In another further preferred embodiment, the automatic transmission oil composition may further include at least one of a viscosity modifier, an antiwear agent and a detergent dispersant.

In still another further preferred embodiment, the viscosity modifier may be any one of polymethylacrylate, olefin copolymer, and polyisobutylene, or a mixture of two or more thereof, the antiwear agent may be any one of zinc alkyl dithiophosphate, flaxseed phosphate, and isobutynyl succinic ester, or a mixture of two or more thereof, and the detergent dispersant may be sulfonate, phenate, or salicylate of alkaline earth metals.

In yet another further preferred embodiment, the automatic transmission oil composition may be applied to the friction material by means of absorption with respect to a clutch of the automatic transmission including a plate and a disk positioned between the plates and attached with the friction material.

The present invention includes the above configurations and thus has the following effects.

According to the present invention, it is possible to obtain an effect of improving a fuel economy of an automobile by improving power transmission efficiency of the clutch.

According to the present invention, it is possible to obtain an effect of improving durability of an automobile by improving abrasion resistance of the clutch.

The effects of the present invention are not limited to the aforementioned effects. It should be understood that the effects of the present invention include all effects inferable from the description below.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a diagram illustrating a clutch of an automatic transmission;

FIG. 2 is a diagram illustrating a friction material of a clutch; and

FIG. 3 is a diagram illustrating a state where the automatic transmission oil composition according to the present invention is adsorbed to the friction material.

Reference numerals set forth in the Drawings includes reference to the following elements as further discussed below:
1: input shaft
10: retainer
12a: fixing groove
21: plate
23: disk
25: friction material
30: hub
40: piston
40a: pressure chamber
41: return spring
43: spring retainer
50: snap ring

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail through exemplary embodiments. The exemplary embodiments of the present invention may be modified in various forms as long as the gist of the invention is not changed. However, the scope of the present invention is not limited to the following exemplary embodiments.

When it is determined that the description for the known configurations and functions may obscure the gist of the present invention, the description for the known configurations and functions will be omitted. In this specification, the term “comprise” means that other constituent elements may be further included unless otherwise listed.

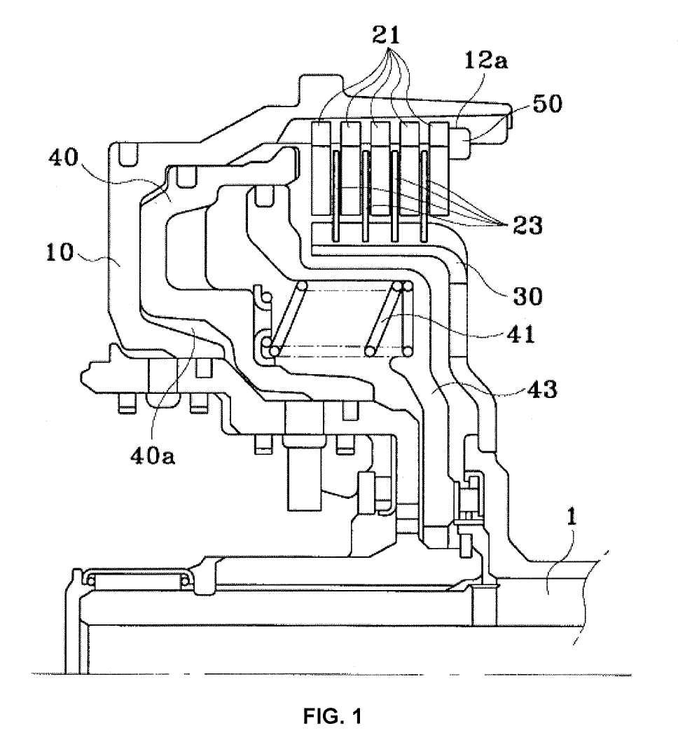

As illustrated in FIG. 1, a clutch used in a vehicle with an automatic transmission includes a retainer 10 coupled to an input shaft 1 disposed at the center in a case of the automatic transmission by a slip joint method and receiving power from the input shaft 1, multiple plates 21 of which outer peripheries are each coupled to the inner periphery of the retainer 10 by the slip joint method, and multiple disks 23 of which the inner peripheries are coupled onto the outer periphery of a hub 30 which is interposed between the multiple plates 21 and connected with a corresponding element of a planetary gear device so as to transmit power by the slip joint method.

A piston 40 is installed in the retainer 10, which moves by receiving pressure from operating oil supplied in accordance with an operation of a hydraulic pressure control device to press the plate 21, a pressure chamber 40a is formed on a rear surface of the piston 40, which permits the operating oil to flow in and flow out, and a return spring 41 and a spring retainer 43 are installed in a space between the hub 30 and the piston 40 to elastically support the piston 40.

A fixing groove 12a having a predetermined depth, which is recessed inwardly is formed in the retainer 10, a circular snap ring 50 made of cast iron and having elastic force is inserted and installed into the fixing groove 12a, and the snap ring 50 supports the plate 21 and the disk 23 and simultaneously supports even an operating load of the piston 40.

When hydraulic pressure of the operating oil is applied to the pressure chamber 40a formed between the retainer 10 and the piston 40 in accordance with the operation of the hydraulic pressure control device during shifting, the piston 40 contacts the disk 23 by pressing the plate 21 over elastic support force of the return spring 41, and as a result, the power may be transmitted to a contact portion between the plate 21 and the disk 23, torque transmitted through the input shaft 1 is transmitted to the hub 30 through the retainer 10, the plate 21, and the disk 23, and the torque is transmitted to the corresponding element of the planetary gear device connected with the hub 30.

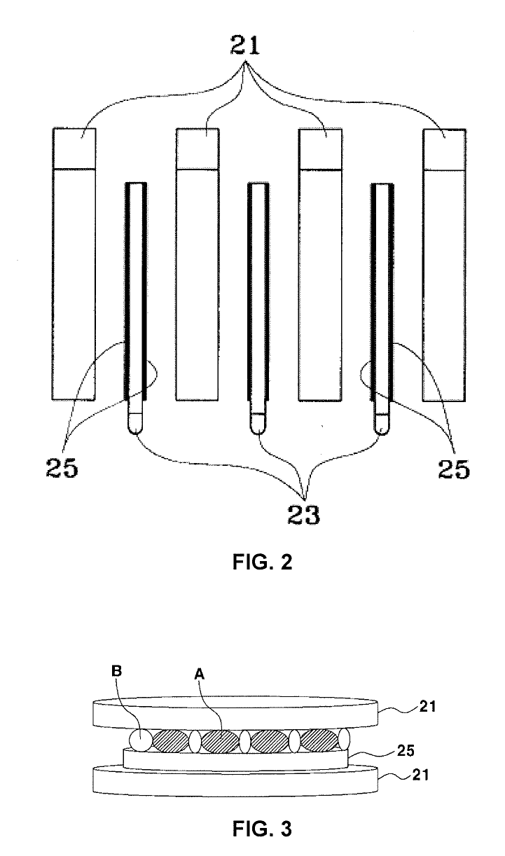

Meanwhile, since the plate 21 and the disk 23 are pressed during high-speed rotation due to structures thereof, serious friction is generated between the plate 21 and the disk 23 and in order to cope with such friction, a friction material 25 is formed on both surfaces of the disk 23 as illustrated in FIG. 2.

An automatic transmission oil composition is used for the friction material 25 by means of absorption, and accordingly, a friction property between the plate 21 and the disk 23 is improved to enhance a fuel economy of the automobile and abrasion resistance of the clutch is improved to enhance durability of the automatic transmission.

The automatic transmission oil composition with improved friction property and fuel economy includes about 68 wt % to 80 wt % (e.g., about 68 wt %, 69, 70, 71, 72, 73, 74, 75, 76, 77, 78, 79, or about 80 wt %) of base oil, about 5 wt % to 15 wt % (about 5 wt %, 6, 7, 8, 9, 10, 11, 12, 13, 14, or about 15 wt %) of polyalkylene glycol oil, and 3 wt % to 10 wt % (e.g., about 3 wt %, 4, 5, 6, 7, 8, 9, or about 10 wt %) of a succinic anhydride derivative represented by the following Chemical Formula 1.

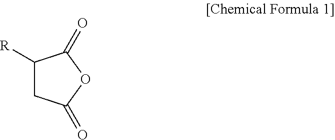

(R is an alkenyl group of C₂-C₃₀.)

Referring to FIG. 3, as described above, the automatic transmission oil composition is adsorbed onto the friction material 25 positioned between the plates 21, and in this case, the polyalkylene glycol oil A and the succinic anhydride derivative B contained in the automatic transmission oil composition are evenly dispersed on the surface of the friction material 25 to improve a friction property of the clutch for the automatic transmission.

The base oil may apply to Group 3 in a classification according to the standard of mineral base oil designated by the American Petroleum Institute (API). The base oil has more than 0 wt % and less than 0.03 wt % as the content of sulfur, 90 wt % or more of saturates, and 120 or more of a viscosity index. Further, the base oil has an advantage of long-term use without deformation due to good adaptability at a low temperature and a high temperature, an antioxidant function, and excellent viscosity retention.

The present invention features the preparation of the automatic transmission oil composition by mixing the polyalkylene glycol oil and the succinic anhydride derivative with the base oil.

The polyalkylene glycol oil is polar synthetic base oil having excellent viscosity temperature property, low temperature fluidity, lubricity and flame retardancy as compared with the base oil. The polyalkylene glycol oil is synthesized by addition-polymerizing alcohols and alkylene oxide (ethylene oxide, propylene oxide, and the like) and a hydroxyl group existing at the terminal thereof is adsorbed onto the friction material to increase a friction coefficient between the friction material and the plate. As a result, adhesion between the friction material and the plate is improved to minimize energy loss by slip.

The polyalkylene glycol oil may be polyethylene glycol, polypropylene glycol or mixtures thereof and particularly, the molecular weight thereof may be about 200 g/mol to about 1,200 g/mol (e.g., about 200 g/mol, 250, 300, 350, 400, 450, 500, 550, 600, 650, 700, 750, 800, 850, 900, 950, 1000, 1050, 1100, 1150, or about 1200 g/mol) and the kinematic viscosity thereof may be about 3 cSt to 6 cSt (e.g., about 3 cSt, 4, 5, or about 6 cSt).

The succinic anhydride derivative is for adjusting a friction coefficient between the plate and the friction material and included in the composition as a kind of friction modifier. The succinic anhydride derivative may be particularly a compound represented by the following Chemical Formula 2, and more particularly by the following Chemical Formula 3.

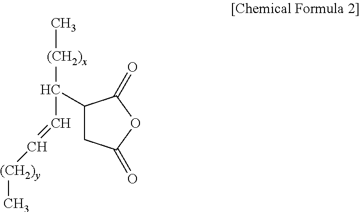

(x and y are integers of 1 to 30, respectively.)

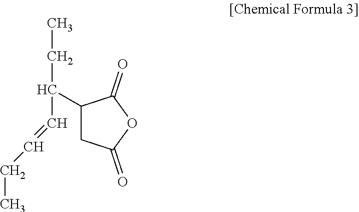

The succinic anhydride derivative is adsorbed onto the friction material by a carbonyl group at the terminal thereof to increase the friction coefficient between the friction material and the plate, thereby improving power transmission efficiency.

The automatic transmission oil composition may include about 5 wt % to 15 wt % (e.g., about 5 wt %, 6, 7, 8, 9, 10, 11, 12, 13, 14, or about 15 wt %) of the polyalkylene glycol oil and 3 wt % to 10 wt % of the succinic anhydride derivative, and particularly, a weight ratio of the polyalkylene glycol oil and the succinic anhydride derivative may be about 0.7 to 3.3:1 (e.g., about 0.7:1, 0.8:1, 0.9:1, 1.0:1, 1.1:1, 1.2:1, 1.3:1, 1.4:1, 1.5:1, 1.6:1, 1.7:1, 1.8:1, 1.9:1, 2.0:1, 2.1:1, 2.2:1, 2.3:1, 2.4:1, 2.5:1, 2.6:1, 2.7:1, 2.8:1, 2.9:1, 3.0:1, 3.1:1, 3.2:1, or about 3.3:1), particularly 1 to 1.7:1, and more particularly 1.4:1.

When the content of the polyalkylene glycol oil is less than 5 wt % or the content of the succinic anhydride derivative is less than 3 wt %, adsorption of the composition onto the friction material is not sufficient, and thus a slip between the friction material and the plate may occur, and the effect of improving the fuel economy of the automobile may be insignificant accordingly.

On the other hand, when the content of the polyalkylene glycol oil is more than 15 wt % or the content of the succinic anhydride derivative is more than 10 wt %, repulsive force between the polyalkylene glycol oil and the succinic anhydride derivative becomes too larger and thus, the adhesion between the friction material and the plate may be deteriorated.

The automatic transmission oil composition according to the present invention may further include at least one of a viscosity modifier, an antiwear agent, and a detergent dispersant.

The viscosity modifier is for decreasing the viscosity of the composition increased when the composition is at a low temperature to allow the clutch to be smoothly operated and increasing the viscosity of the composition decreased when the composition is at a high temperature to prevent friction and abrasion between metals from occurring, and may be any one of polymethylacrylate, olefin copolymer and polyisobutylene, or a mixture of two or more thereof.

The antiwear agent is a configuration of alleviating the degree of abrasion of the friction material, the plate, and the like and may be any one of zinc alkyl dithiophosphate, flaxseed phosphate, and isobutynyl succinic ester, or a mixture of two or more thereof.

The detergent dispersant is for dispersing and floating sludge or carbon powder generated by oxidation of the composition in a very fine particle state to clearly maintain the clutch, and may be sulfonate, phenate or salicylate of alkaline earth metals such as calcium, magnesium, and barium.

The automatic transmission oil composition may further include additives which are generally added to lubricating oil and the like. The additives may be particularly an ashless dispersant, an antioxidant, a corrosion inhibitor, an antifoamer, and the like.

Hereinafter, the present invention will be described in more detail through detailed Examples. However, these Examples are to exemplify the present invention and the scope of the present invention is not limited thereto.

### EXAMPLES

The following examples illustrate the invention and are not intended to limit the same.

### Examples 1 to 5 and Comparative Examples 1 to 3

An automatic transmission oil composition was prepared by stirring and mixing the compositions listed in Table 1 below.

TABLE 1

| | | | | | | Comparative | | |
|---|---|---|---|---|---|---|---|---|
| | Example | | | | | Example | | |
| Classification (wt %) | 1 | 2 | 3 | 4 | 5 | 1 | 2 | 3 |
| Base oil¹⁾ | 78.5 | 76.5 | 73.5 | 71.5 | 68.5 | 83.5 | 80.5 | 66.5 |
| Polyalkylene glycol oil²⁾ | 5 | 7 | 10 | 12 | 15 | — | 3 | 17 |
| Succinic anhydride derivative³⁾ | 7 | 7 | 7 | 7 | 7 | 7 | 7 | 7 |
| Viscosity modifier⁴⁾ | 5 | 5 | 5 | 5 | 5 | 5 | 5 | 5 |
| Antiwear agent⁵⁾ | 3 | 3 | 3 | 3 | 3 | 3 | 3 | 3 |
| Detergent dispesant⁶⁾ | 1.5 | 1.5 | 1.5 | 1.5 | 1.5 | 1.5 | 1.5 | 1.5 |

¹⁾Group 3 Base oil (SK Corporation, Yubase-3, 100° C. kinematic viscosity 3 cSt)
²⁾Polyalkylene Glycols (Dow Corporation, OSP-18, 100° C. Kinematic viscosity 4 cSt)
³⁾Alkenyl Substituted Succinic Anhydride (Infineum Corporation)
⁴⁾Comb Polymethacrylate (Rohmax Corporation, Number average molecular weight/about 180,000)
⁵⁾Zinc alkyldithiophosphate (Infineum Corporation)
⁶⁾Calcium salicylate (Infineum Corporation)

The Examples 1 to 5 are a composition including 5 wt % to 15 wt % of polyalkylene glycol oil and 1.5 wt % of a succinic anhydride derivative. On the other hand, Comparative Example 1 is a composition without polyalkylene glycol oil, Comparative Example 2 is a composition including less than 5 wt % of polyalkylene glycol oil, and Comparative Example 3 is a composition including more than 15 wt % of polyalkylene glycol oil.

Dynamic friction coefficients, non-combustable friction torque improvement rates, fuel economy improvement rates, and iron (Fe) abrasion contents after driving durability of the compositions according to the Examples 1 to 5 and the Comparative Examples 1 to 3 were evaluated by the following method.

Dynamic friction coefficient: Evaluated by JASOM348 test method. Particularly, dynamic friction between the friction material and the plate was measured under the conditions of 3,600 RPM, 785 kPa, and 120° C.

Non-combustable friction torque improvement rate: A friction torque for each condition of the automatic transmission during non-combustable operation was measured and evaluated. The non-combustable operation was performed under the conditions of 800 RPM to 2,500 RPM and 25° C. to 90° C. An improved degree as compared with Comparative Example 1 was calculated and evaluated by a percentage based on the measured value of Comparative Example 1.

Fuel economy improvement ratio: The fuel economy improvement ratio was evaluated by a chassis dynamo under a specific operating condition through a FTP 75 test mode, which is the North American authentication mode. The FTP 75 test mode was continuously performed in order of a cold start phase, a transient phase, an engine step and a hot start phase. The cold start phase had a driving time of 505 seconds, a maximum speed of 91.2 km/h, an average speed of 40.4 km/h and a driving distance of 5.79 km, the transient phase had a driving time of 865 seconds, a maximum speed of 55.2 km/h, an average speed of 25.6 km/h, a driving distance of 6.25 km, and an engine stop time of 600 seconds, and the hot start phase had a driving time of 505 seconds, a maximum speed of 91.2 km/h, an average speed of 40.4 km/h, and a driving distance of 5.79 km. Based on an actual fuel economy of a test vehicle, the degree of improvement was calculated and evaluated as a percentage.

Iron (Fe) abrasion contents after driving durability: The iron (Fe) abrasion contents after driving durability was evaluated for about 300 hours while shifting to 1 to 6 stages at an engine speed of 2,000 RPM to 7,000 RPM and a load of 100 N to 300 N.

The result is listed in Table 2 below.

TABLE 2

| | Example | | | | | Comparative Example | | |
|---|---|---|---|---|---|---|---|---|
| Evaluation items | 1 | 2 | 3 | 4 | 5 | 1 | 2 | 3 |
| Dynamic friction coefficient | 0.132 | 0.134 | 0.135 | 0.133 | 0.132 | 0.129 | 0.130 | 0.130 |
| Non-combustable friction | 7 | 9 | 11 | 9 | 6 | standard | 1 | 2 |
| torque improvement rate [%] | | | | | | | | |
| Fuel economy | 0.3 | 0.3 | 0.4 | 0.3 | 0.2 | 0 | 0 | 0 |
| improvement rate [%] | | | | | | | | |
| Iron (Fe) abrasion contents | 120 | 120 | 100 | 120 | 110 | 200 | 180 | 180 |
| after driving durability [ppm] | | | | | | | | |

Referring to Table 2, as compared with Comparative Examples 1 to 3, in Examples 1 to 5 including 5 wt % to 15 wt % of polyalkylene glycol oil, it was verified that the dynamic friction coefficient, the non-combustable friction torque improvement rate, and the fuel economy improvement rate were high and the iron (Fe) abrasion content after driving durability was low. Accordingly, it can be expected that when the compositions of Example 1-5 are used, the friction coefficient of the clutch may be increased to improve power transfer efficiency of the automatic transmission, thereby improving fuel economy of the vehicle and ensuring abrasion resistance of the automatic transmission.

### Examples 6 to 9 and Comparative Examples 4 and 5

An automatic transmission oil composition was prepared by stirring and mixing the compositions listed in Table 3 below.

TABLE 3

| | | | | | Comparative | |
|---|---|---|---|---|---|---|
| | Example | | | | Example | |
| Classification (wt %) | 6 | 7 | 8 | 9 | 4 | 5 |
| Base oil¹⁾ | 77.5 | 75.5 | 73.5 | 70.5 | 78.5 | 68.5 |
| Polyalkylene glycol oil²⁾ | 10 | 10 | 10 | 10 | 10 | 10 |
| Succinic anhydride | 3 | 5 | 7 | 10 | 2 | 12 |
| derivative³⁾ | | | | | | |
| Viscosity modifier⁴⁾ | 5 | 5 | 5 | 5 | 5 | 5 |
| Antiwear agent⁵⁾ | 3 | 3 | 3 | 3 | 3 | 3 |
| Detergent dispesant⁶⁾ | 1.5 | 1.5 | 1.5 | 1.5 | 1.5 | 1.5 |

¹⁾Group 3 Base oil (SK Corporation, Yubase-3, 100° C. kinematic viscosity 3 cSt)
²⁾Polyalkylene Glycols (Dow Corporation, OSP-18, 100° C. Kinematic viscosity 4 cSt)
³⁾Alkenyl Substituted Succinic Anhydride (Infineum Corporation)
⁴⁾Comb Polymethacrylate (Rohmax Corporation, Number average molecular weight/about 180,000)
⁵⁾Zinc alkyldithiophosphate (Infineum Corporation)
⁶⁾Calcium salicylate (Infineum Corporation)

The Examples 6 to 9 are compositions including 10 wt % of polyalkylene glycol oil and 3 wt % to 10 wt % of a succinic anhydride derivative. On the other hand, Comparative Example 4 is a composition including less than 3 wt % of the succinic anhydride derivative and Comparative Example 5 is a composition including more than 10 wt % of the succinic anhydride derivative.

Dynamic friction coefficients, non-combustable friction torque improvement rates, fuel economy improvement rates, and iron (Fe) abrasion contents after driving durability of the compositions according to Examples 6 to 9 and the Comparative Examples 4 and 5 were evaluated by the above-mentioned methods. The result is listed in Table 4 below.

TABLE 4

| | | | | | Comparative | |
|---|---|---|---|---|---|---|
| | Example | | | | Example | |
| Evaluation items | 6 | 7 | 8 | 9 | 4 | 5 |
| Dynamic friction coefficient | 0.133 | 0.134 | 0.135 | 0.134 | 0.130 | 0.130 |
| Non-combustable friction | 6 | 9 | 11 | 9 | 2 | 1 |
| torque improvement rate [%] | | | | | | |
| Fuel economy | 0.2 | 0.3 | 0.4 | 0.3 | 0 | 0 |
| improvement rate [%] | | | | | | |
| Iron (Fe) abrasion contents | 120 | 110 | 100 | 120 | 170 | 180 |
| after driving durability [ppm] | | | | | | |

Referring to Table 4, as compared with Comparative Examples 4 and 5, in Examples 6 to 9 including 3 wt % to 10 wt % of the succinic anhydride derivative, it was verified that the dynamic friction coefficient, the non-combustable friction torque improvement rate, and the fuel economy improvement rate were high and the iron (Fe) abrasion content after driving durability was low. Accordingly, it can be expected that when the compositions of Example 6 to 9 are used, the friction coefficient of the clutch may be increased to improve power transfer efficiency of the automatic transmission, thereby improving fuel economy of the vehicle and ensuring abrasion resistance of the automatic transmission.

Particularly, referring to Tables 2 and 4, it can be seen that Examples 3 and 8 in which a weight ratio of the polyalkylene glycol oil and the succinic anhydride derivative is 1.4:1 have the most excellent improvement effect of fuel economy and friction torque and the most excellent durability.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An automatic transmission oil composition with improved friction property and fuel economy, the composition comprising:
about 68 wt % to 80 wt % of base oil;
about 5 wt % to 15 wt % of polyalkylene glycol oil; and
about 3 wt % to 10 wt % of a succinic anhydride derivative represented by the following Chemical Formula 1. 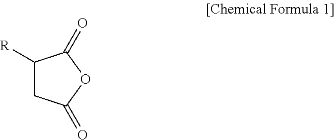
(R is an alkenyl group of C₂-C₃₀.)

2. The composition of claim 1, wherein the polyalkylene glycol oil has a molecular weight of about 200 g/mol to 1,200 g/mol.

3. The composition of claim 1, wherein the polyalkylene glycol oil has a kinematic viscosity of about 3 cSt to 6 cSt.

4. The composition of claim 1, wherein the polyalkylene glycol oil is any one of polyethylene glycol and polypropylene glycol or mixtures thereof.

5. The composition of claim 1, wherein the succinic anhydride derivative is a compound represented by the following Chemical Formula 2. 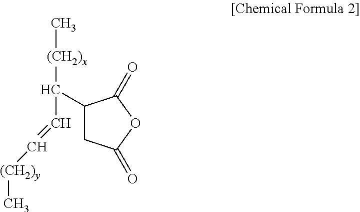
(x and y are integers of 1 to 30, respectively.)

6. The composition of claim 5, wherein the succinic anhydride derivative is a compound represented by the following Chemical Formula 3.

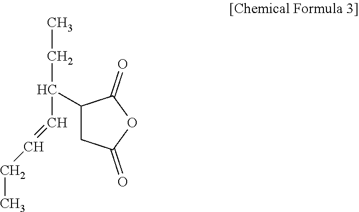

7. The composition of claim 1, wherein a weight ratio of the polyalkylene glycol oil and the succinic anhydride derivative is about 0.7 to 3.3:1.

8. The composition of claim 1, further comprising:
any one of a viscosity modifier, an antiwear agent, and a detergent dispersant.

9. The composition of claim 8, wherein the viscosity modifier is any one of polymethylacrylate, olefin copolymer, and polyisobutylene, or a mixture of two or more thereof, the antiwear agent is any one of zinc alkyl dithiophosphate, flaxseed phosphate, and isobutynyl succinic ester, or a mixture of two or more thereof, and the detergent dispersant is sulfonate, phenate, or salicylate of alkaline earth metals.

10. A clutch of an automatic transmission, the clutch comprising:
a plate; and
a disk positioned between the plates and attached with a friction material,
wherein the composition of claim 1 is adsorbed to the friction material.
